(19) United States
(12) Patent Application Publication
(10) Pub. No.: US 2024/0151211 A1
(43) Pub. Date: May 9, 2024

(54) Pitch Bearing Condition Monitoring

(71) Applicant: Insight Analytics Solutions Holdings Limited, Sunbury On Thames Middlesex (GB)

(72) Inventors: Robin Neil Ronald Elliott, Nottingham (GB); Ashley Crowther, Nottingham (GB); Richard Smith, Nottingham (GB); John Karl Coultate, Nottingham (GB); Gareth Morris, Nottingham (GB)

(21) Appl. No.: 18/549,876

(22) PCT Filed: Mar. 10, 2022
(86) PCT No.: PCT/GB2022/050629

§ 371 Date: Sep. 8, 2023

(30) Foreign Application Priority Data
Mar. 10, 2021 (GB) 2103319.6

(51) Int. Cl. F03D 17/00; G01M 13/04

(52) U.S. Cl. CPC F03D 17/032; F03D 17/012; G01M 13/04; F05B 2260/79

(57) ABSTRACT

The disclosure relates to condition monitoring of wind turbine pitch bearings by measuring variations in distance between inner and outer rings of a pitch bearing during an angular rotation. Example embodiments include a method of monitoring a condition of a pitch bearing (100) of a wind turbine, the pitch bearing comprising a first ring (102) attached to a blade of the wind turbine and a second ring (103) attached to a hub of the wind turbine, the method comprising: mounting a displacement sensor (105) to the pitch bearing (100) to measure a distance between the first ring (102) and the second ring (103); rotating the first ring (102) relative to the second ring (103) over an angular range; and recording an angular position (204) of the first ring (102) relative to the second ring (103) and a distance (205a, 205b) measured by the displacement sensor (105) while rotating the first ring (103) relative to the second ring (103) over the angular range.

### FIELD OF THE INVENTION

The invention relates to condition monitoring of wind turbine pitch bearings by measuring variations in distance between inner and outer rings of a pitch bearing during an angular rotation.

### BACKGROUND

Wind turbine pitch bearings undergo high loadings during operation. Predicting failure of pitch bearings is problematic due to the inherent variability of operation under varying conditions. Typical usage of a pitch bearing will involve a maximum range of rotation of up to 90 degrees but, for a majority of the time a pitch bearing is operational, the amount of rotation may be much smaller, for example only a few degrees. Small repeated and unpredictable variations, for example in response to wind speed to optimise loading of the wind turbine, typically results in heavy wear that may eventually result in cracking and, in extreme cases, catastrophic failure. It is therefore important to be able to regularly monitor the condition of pitch bearings over the operational lifetime of a wind turbine. This may typically be done by regular visual inspections, checking for any signs of excessive wear or cracking and periodically refreshing lubricant, for example as disclosed in EP 2937564 B1. Excessive loading that may eventually lead to cracking can in some cases be prevented or reduced by installing a bearing compression strap, for example as disclosed in EP 3344884 B1. This will not, however, prevent or reduce wear of the internal parts of a pitch bearing, i.e. the bearings and races of the pitch bearing structure.

Measuring an amount of vibration of a pitch bearing during a pitching movement may be used to determine a condition of the pitch bearing, as for example disclosed in EP 3511562 A1. Measuring vibration or acoustic emission can, however, be complicated by sources of vibration other than those resulting from the bearings and rings themselves. It would therefore be advantageous to provide a way of monitoring the condition of a wind turbine pitch bearing that can avoid or possibly augment existing vibration measurement techniques.

### SUMMARY OF THE INVENTION

In accordance with a first aspect of the invention there is provided a method of monitoring a condition of a pitch bearing of a wind turbine, the pitch bearing comprising a first ring attached to a blade of the wind turbine and a second ring attached to a hub of the wind turbine, the method comprising:
mounting a displacement sensor to the pitch bearing to measure a distance between the first ring and the second ring;
rotating the first ring relative to the second ring over an angular range; and
recording an angular position of the first ring relative to the second ring and a distance measured by the displacement sensor while rotating the first ring relative to the second ring over the angular range.

In a typical wind turbine pitch bearing, the first ring is an outer ring and the second ring is an inner ring. In alternative examples, the inner ring may be connected to the blade and the outer ring to the hub.

The displacement sensor may be mounted to measure a distance parallel to a rotational axis of the pitch bearing. The actual distance measured does not need to be exactly parallel, provided that a measurable component of the distance measured is parallel to the rotational axis. The distance measured enables a measure of how uniformly the rings rotate relative to each other, since any non-uniformity will tend to result in an axial displacement. In some cases, it may be advantageous or preferable to mount the displacement sensor to measure displacement orthogonal to the rotational axis, for example where a uniform planar surface of one of the rings is not accessible or available and a curved surface of the ring may instead only be available to measure against.

The step of recording may be carried out while a main rotor of the wind turbine is stationary, i.e. while the wind turbine is not operational. During such recording, one of the (typically) three blades of the wind turbine may have its longitudinal axis aligned vertically. In some cases, the step of recording may be carried out while the main rotor is rotating, i.e. while the wind turbine is operational. Carrying out the step of recording while the wind turbine rotor is stationary avoids any load variations resulting from rotation of the wind turbine rotor from interfering with the displacement measurements. Carrying out the step of recording while the main rotor is rotating may in some cases be useful, for example to provide more continuous monitoring of one or more pitch bearings of the wind turbine during service. An orientation of the wind turbine rotor may also be recorded during such recordings, so that the position of the blade over time can be known to allow for fluctuating loads to be taken into account. An orientation of the main rotor may be available from a controller of the wind turbine or may be measured, for example by use of an optical encoder or orientation sensor on the main rotor.

The recorded angular position may be derived from a measurement of:
a gravity vector;
an elapsed time and a rotation rate; or
a detected position of the second ring relative to the first ring.

Measuring the angular position from a gravity vector may for example be done by mounting an accelerometer or orientation sensor on the ring that is rotating, i.e. the ring attached to the blade. The orientation as measured may then be determined based on a known orientation of the blade relative to the horizontal. The rotational axis of the pitch bearing being measured may for example be oriented horizontally and the angular range measured by a change in gravity vector between vertical and horizontal, i.e. over a 90 degree range, representing a typical full normal operating range of a wind turbine pitch bearing.

Measuring an elapsed time and a rotation rate may alternatively be used to determine the angular position, since the starting and ending position will be known and the rate of rotation may be uniform.

An alternative measure of angular position may be provided by detecting a position of the second ring relative to the first ring, for example from an encoder on the pitch bearing. A position may in some cases be determined by detecting the passage of bolts on the pitch bearing, which will tend to be placed at regularly spaced intervals.

The method may comprise determining a variation in the measured distance over the angular range and estimating a condition of the pitch bearing based on the variation.

In accordance with a second aspect of the invention there is provided a method of determining a condition of a pitch bearing of a wind turbine, the pitch bearing comprising a first ring attached to a hub of the wind turbine, a second ring attached to a blade of the wind turbine and a rotational axis, the method comprising:
providing a recording of an angular position of the first ring relative to the second ring and a distance between the first ring and the second ring over the angular range;
determining a variation in the distance over the angular range; and
estimating a condition of the pitch bearing based on the variation.

In accordance with either the first or second aspect, estimating a condition of the pitch bearing may comprise comparing the variation in the measured distance with one or more of:
a previously stored variation in measured distance for the pitch bearing;
a modelled variation in distance for the pitch bearing;
a recorded variation in measured distance for one or more other pitch bearings of the same type.

A previously stored variation in measured distance may for example be one or more previously measurements carried out on the same bearing in situ, i.e. on the wind turbine, or may be a measurement carried out prior to installation. The previously stored variation may thereby provide a baseline to compare the measurement with, enabling a change over time to be detected.

A modelled variation in distance of the pitch bearing may be used for comparison instead or as well as previously stored measurements. A modelled variation may be determined from various parameters relating to the pitch bearing, for example the size and stiffness of the components and clearances between the inner and outer rings, together with known loadings resulting from rotation of the pitch bearing in situ.

A recorded variation for other pitch bearings of the same type may for example relate to other pitch bearings on the same wind turbine and/or on another wind turbine. When, for example, determining the condition of multiple pitch bearings over a number of wind turbines on a common wind turbine installation, if all are of the same type a useful measure of variation, particularly if no prior recordings are available, is to identify any particular outliers, i.e. pitch bearings having variations that are at the extreme end of variation in measured distance so that these can be investigated in more detail.

Determining a variation in the measured distance over the angular range may comprise determining a quality value from one or more of:
a peak to peak value of the measured displacement over the angular range;
an RMS value of the measured displacement over the angular range;
a measure of deviation from a mean value of the measured displacement over the angular range; and
a kurtosis value of the measured displacement over the angular range.

Each of these quality values will provide a measure of how much the displacement varies over the angular range. In general, a higher peak to peak or RMS value will tend to indicate a poorer condition. These measures may, however, in some cases not be able to identify an increase in extreme variations across the angular range, in which case a measure of deviation from a mean value may be useful. This measure may for example be kurtosis, i.e. a measure of the shape of the distribution of displacements over the angular range. Kurtosis can thereby determine whether a distribution has outlier values, which may be evident in displacements having large isolated peaks.

The quality value may be compared to a predetermined threshold value, with an increased quality value indicating a poorer condition. If the quality value exceeds the threshold, a notification output may be provided. This can, for example, be useful when analysing multiple measurements taken across a number of pitch bearings, enabling particular pitch bearings to be identified for further analysis, investigation, repair or replacement.

The method may be performed upon being triggered by an event. The event may be time-based or detection of a pitching operation of the pitch bearing.

Pitching operation of the pitch bearing may be detected by a rotation sensor configured to detect rotation of the first ring relative to the second ring.

In accordance with a third aspect, there is provided a method of determining a condition of a pitch bearing of a wind turbine, the pitch bearing comprising a first ring attached to a blade of the wind turbine and a second ring attached to a hub of the wind turbine, the method comprising:
monitoring displacement of the first ring in an axial direction with a displacement sensor, the axial direction being parallel to a rotational axis of the pitch bearing;
upon detection of a triggering event, recording the displacement over a set period to provide a recorded displacement;
determining a variation in displacement over time from the recorded displacement; and
estimating a condition of the pitch bearing based on the variation.

The triggering event may be one or more of: a time-based event; a measure of rotation of the first ring; and a measure of displacement by the displacement sensor outside a preset threshold.

The set period for recording may be defined by a set time period, a number of samples or a measure of rotation of the first ring.

Other features of the first and second aspects may also be applied to the third aspect.

In accordance with a fourth aspect of the invention there is provided a computer program comprising instructions for causing a computer to perform the method according to the second or third aspects. The computer program may be stored on a non-volatile storage medium.

### DETAILED DESCRIPTION

The invention is described in further detail below by way of example and with reference to the accompanying drawings, in which:

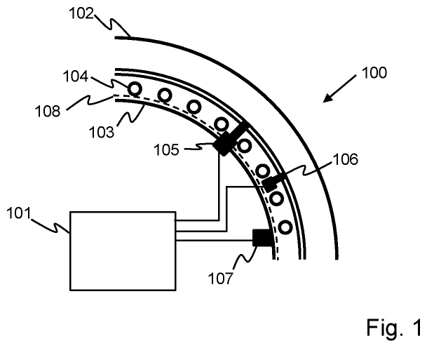

FIG. 1 is a schematic plan view of a measurement apparatus for monitoring a condition of a pitch bearing;

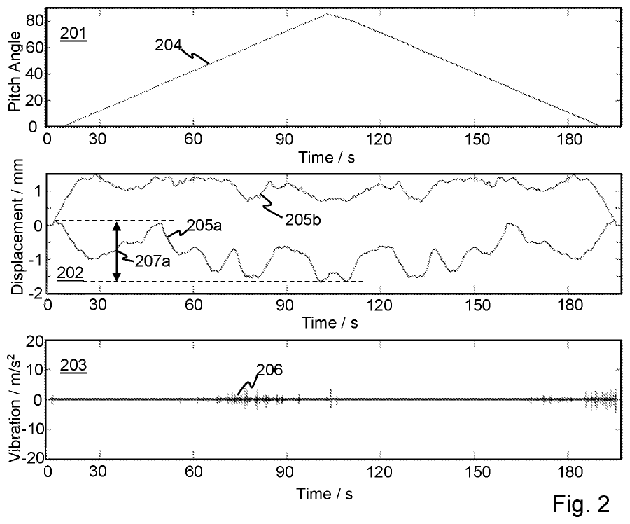

FIGS. 2, 3 and 4 are series of measurements of pitch angle, displacement and vibration over time during rotation of different pitch bearings on a common wind turbine;

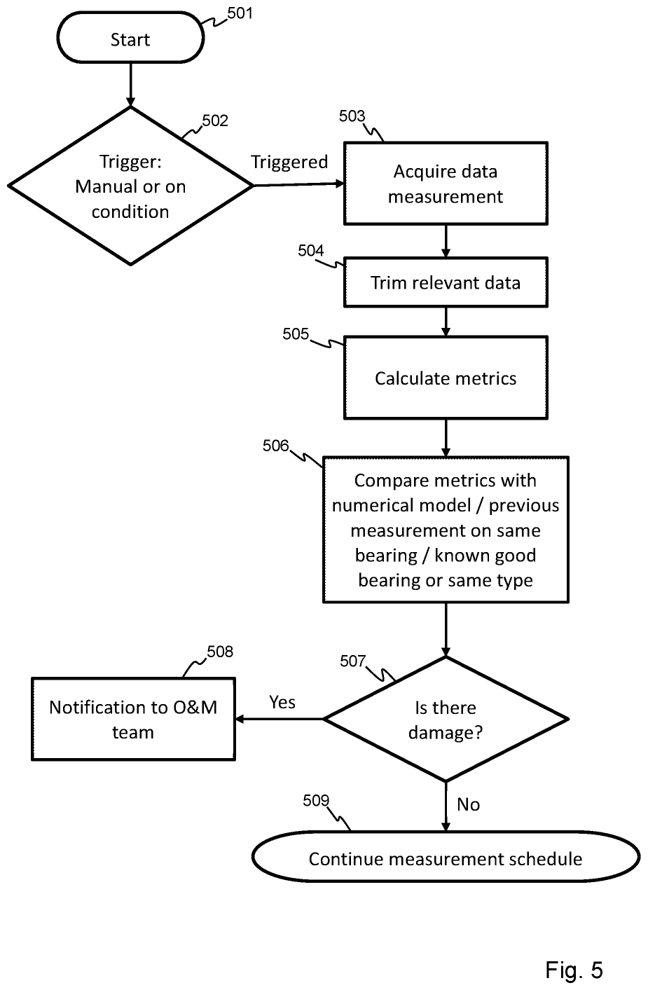

FIG. 5 is a schematic flow diagram illustrating an example method of monitoring and determining a condition of a pitch bearing of a wind turbine;

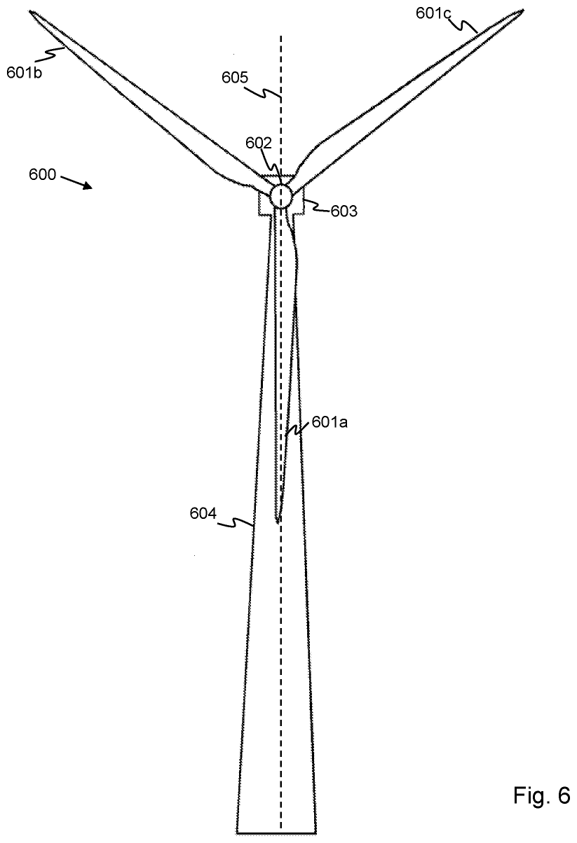

FIG. 6 is a schematic elevation view of an example wind turbine; and

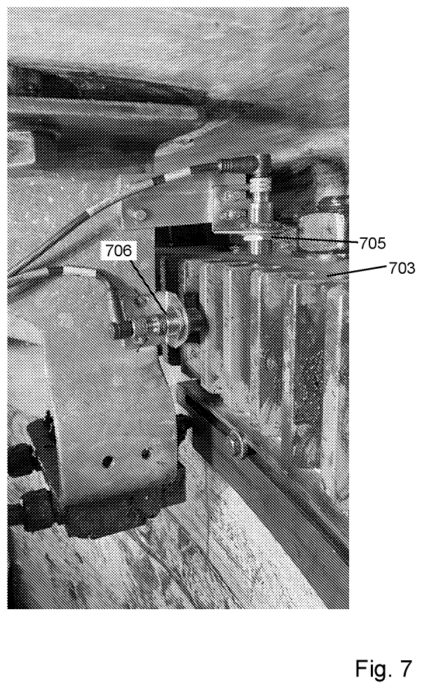

FIG. 7 is a photograph of an example arrangement of a displacement sensor and rotation sensor mounted for monitoring a wind turbine pitch bearing.

FIG. 1 illustrates a portion of a pitch bearing 100 connected to a recorder 101 arranged to monitor the condition of the pitch bearing 100. The pitch bearing 100 comprises an outer ring 102 and an inner ring 103. The inner ring 103 may be connected to the hub of the wind turbine (not shown; see FIG. 6), while the outer ring 102 may be connected to a blade (not shown; also see FIG. 6). The blade may be pitched over an angular range by rotating the outer ring 102 around the inner ring. A regularly spaced series of bolts 104 may secure the inner ring 103 to the hub. The inner ring 103 may alternatively be connected to the blade and rotated relative to the outer ring 102 connected to the hub.

The recorder 101 may for example be a general-purpose computer comprising an interface arranged to receive various sensor measurements or may be a dedicated recorder arranged to receive and store measurement data and provide this data periodically to an external computer for analysis. Recording of the measurement data and analysis of the data may be carried out by the same recorder 101 or may be carried out separately, for example by transmitting or transferring recorded data to a remote computer.

The recorder 101 is connected to a displacement sensor 105, which is mounted to the outer ring 102 and positioned to detect a distance to a planar surface of the inner ring 103. The displacement sensor 105 shown in FIG. 1 is positioned to detect a distance to a portion of the inner ring 103 indicated by dotted line 108 defining a circular path around the inner ring 103.

To record an angular position of the inner ring 103 the recorder 101 may be connected to an angular position sensor 106 and/or an accelerometer or orientation sensor 107. The angular position sensor 106 may for example be a digital proximity sensor fixed to the outer ring 102 and positioned to detect each of the bolts 104 as they pass so that the angular position of the inner ring can be determined. The accelerometer or orientation sensor 107 may alternatively or additionally be used by detecting an orientation of the inner ring 103, which can also be used to determine an angular position. The accelerometer 107, or another accelerometer or acoustic sensor, may alternatively be used to measure vibration during rotation of the pitch bearing 100. The recorder 101 may alternatively be connected to receive an encoder signal indicating an angular position of the inner ring 103, which may be provided as a signal from a controller of the wind turbine. By recording signals from the displacement sensor 105 as a function of time and one or more other signals that provide an indication of an angular position of the pitch bearing as a function of time, recorded measurements can be used to determine a measure of displacement as a function of relative angular position between the inner ring 103 and outer ring 102. A vibration or acoustic emission signal may also be recorded as a function of time.

In an example measurement, each of three pitch bearings of a wind turbine were fitted with displacement sensors to measure a distance to a planar surface of the inner ring of each pitch bearing, in a similar arrangement to that illustrated in FIG. 1. Accelerometers were also fitted to the inner ring of each pitch bearing to measure vibration. All data sources were sampled synchronously during a pitching operation. Two inductive displacement sensors were fitted to each pitch bearing, the sensors being placed around 180 degrees apart. Two accelerometers with a sensitivity of 100 mV/g were fitted to the inner ring of each bearing, also 180 degree apart. A further accelerometer was fitted to the pitch drive arranged to drive rotation of the outer ring relative to the inner ring. An inductive proximity sensor was also fitted to detect passage of the bolts on the inner ring. The rotor was locked with one of the three blades oriented with its longitudinal axis vertical (see FIG. 6) while a measurement was carried out on one of the other two blades, which were oriented at around 60 degrees to the vertical. For each measurement, the respective blade was commanded to carry out a full pitch sweep from around 0 degrees to around 90 degrees and back, while the displacement and vibration signals were recorded. Several runs were taken with different pitching speeds to check repeatability.

FIGS. 2, 3 and 4 illustrate a series of example measurements taken on each of the three pitch bearings of the wind turbine. Referring to FIG. 2, a first plot 201 shows a measure of pitch angle (in degrees) as a function of time. A second plot 202 shows a measure of displacement (in mm) as a function of time. A third plot 203 shows a measure of vibration (in m/s²) as a function of time. Two measures of displacement 205a, 205b are output, a first displacement trace 205a being measured at an opposite side to a second trace 205b (trace 205a measured at the upwind side, 206a at the downwind side).

In this case, the peak-to-peak displacement 207a is around 1.5 mm and the overall trace shows multiple peaks over the angular range. The vibration trace 206 also shows multiple peaks, notably around 50 to 70 degrees on the forward pitch angle movement and towards the end of the reverse movement, showing a series of sharp impacts spaced at around 0.3 Hz. A comparison of the two bearing vibration traces with a further pitch drive vibration trace revealed this to be indicative of a fault in the bearing rather than in the pitch drive because peaks were observed from the pitch bearing around 20 ms before that in the pitch drive.

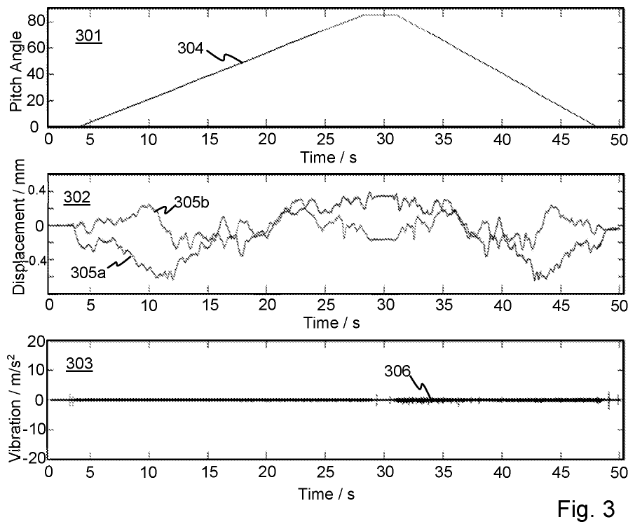

FIG. 3 shows corresponding plots 301, 302, 303 for a second pitch bearing of the wind turbine, showing traces of pitch angle 304, displacement 305a, 305b and vibration 306. A peak-to-peak measure of the displacement traces 305a, 305b is around 0.9 mm and the vibration trace 306 shows lower magnitude vibrations with fewer and smaller spikes.

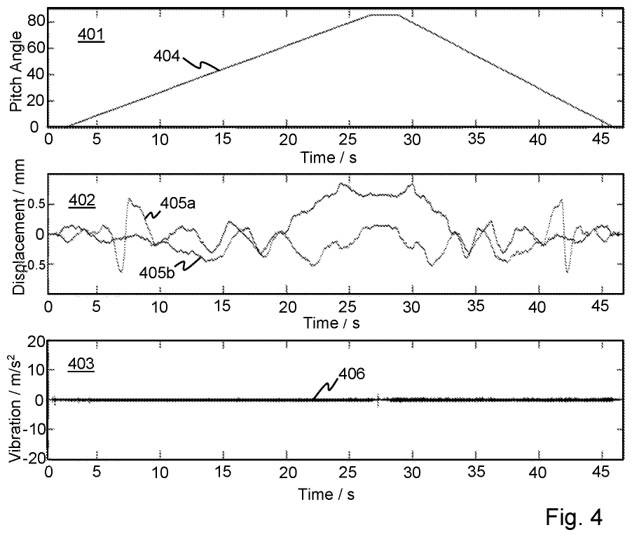

FIG. 4 shows corresponding plots 401, 402, 403 for a third pitch bearing of the wind turbine, showing traces of pitch angle 404, displacement 405a, 405b and vibration 406. Some impacts are visible in the vibration trace and moderate changes in displacement. A notable feature in the displacement trace 405a is a peak of around 1.1 mm at around the 20 degree position in both directions. The overall peak to peak displacement is around 1.1 mm.

In each of the displacement traces, a general feature is that the traces are symmetrical, i.e. show similar shape traces in each pitch direction. This may be used as a check to determine whether the displacement measurements have been performed correctly. If the displacement measurement taken over the angular range in a first direction is sufficiently close to that taken over the angular direction in a second opposite direction then the measurement may be determined to be correctly taken. An error measure may for example be determined from data series of displacement and pitch in the first and second directions to provide a displacement measurement quality value. This may for example be in the form of an R² value, which will be closer to 1 if the displacement measurements are closely matched. A lower R² value, for example below around 0.9, will tend to indicate a measurement error. In a general aspect therefore, a measure of symmetry of displacement as a function of angular position may be determined by comparing displacement as a function of angular position in first and second opposing directions. The measure of symmetry may for example be a measure of fit between displacement in the first and second opposing directions. A notification may be output if the symmetry, for example as measured by the measure of fit, is below a threshold value. The threshold may for example be around 0.9 of an R² measure of fit.

A further feature to note from the displacement traces is that significant deterioration in a pitch bearing may not be evident from vibration analysis alone. In FIG. 4, for example, a significant peak and trough is evident on both upward and downward portions of the displacement trace 405a, although the vibration analysis does not indicate a significant issue. A further problem with vibration analysis is that the peaks in vibration do not necessarily correspond with particular portions of the angular range so may not be repeatable, whereas the displacement traces can be seen to be highly repeatable due to their symmetry. Displacement analysis can therefore provide a more reliable measure of deterioration of a pitch bearing, particularly if taken regularly over time.

FIG. 5 is a schematic flow diagram illustrating an example method of monitoring a condition of a pitch bearing of a wind turbine. The method starts 501 and is triggered 502 either manually or on a condition, for example once a time period has elapsed since a previous measurement and provided the wind turbine is in a condition ready for a measurement to take place (which may, for example, require wind conditions to be low). Once triggered, the process of data acquisition is carried out (step 503), for example by performing a pitch rotation over an angular range, and acquiring displacement and angular data, optionally also with vibration information if a vibration sensor is used. The data may be recorded locally and accessed either locally or remotely from the wind turbine. A permanently installed measurement apparatus may for example be used, which periodically performs data acquisition and transmits the recorded data to a remote computer. The measurement process may therefore be automated or may be carried out during operation of the wind turbine and recordings transmitted at regular intervals. A measurement apparatus, whether permanently or temporarily installed, may alternatively be used to record data that is then either analysed locally or taken away for analysis.

In the analysis stage, the relevant data may first be trimmed (step 504), for example to remove excess portions of recorded data prior to and after movement of the pitch bearing. A trimming operation may be necessary when handling longer term recordings, in which pitch angle changes may be infrequent. The data may be analysed to determine at what points the pitch angle changes by more than a threshold value, for example by more than 10 degrees and this portion used for further analysis. Alternatively, some or all of the recorded data may be analysed using displacement as a function of pitch angle. If the measurements are taken while the wind turbine is operational, i.e. when the main hub is rotating, account may be taken of the varying load expected as functions of angular position and rotational speed of each blade. The angular position of the wind turbine hub may for example be determined and recorded by an encoder mounted on the hub.

The data is then analysed to calculate one or more metrics (step 505), as described above. Possible metrics may include one or more of the following:
Peak to peak, maximum or RMS measures of displacement;
Closeness of fit to an idealised or modelled curve;
Comparison to a mean calculated from a population of pitch bearings of the same type, for example using a Z-score or other statistical quantity;
A metric to quantify the level of peaking in the measured displacement, for example kurtosis;
A measure of displacement variation as a function of frequency, for example to isolate higher frequency movements that may indicate damage from a low frequency general shape that is less likely to represent damage;

In addition to calculating metrics based on displacement, calculations may also be taken based on a speed of rotation during data acquisition, such as measuring a variation in pitch speed (e.g. by calculating a standard deviation about a nominal speed) and comparing the pitch speed with a motor current and/or hydraulic pressure. Significant variation in a nominal pitch speed may indicate a problem with the pitch motor.

After calculation of metrics, a comparison may then be made (step 506) of the metrics with a numerical model, previous measurements on the same bearing or on another bearing of the same type. If damage is indicated (step 507), for example by the quality value indicated by the metric(s), a notification may be provided (step 508), otherwise a measurement schedule may be continued with (step 509).

An additional check may be included in step 507 if further measurement data is acquired such as vibration information. If, for example, a quality value based on the displacement measurements is over a threshold that indicates the pitch bearing is damaged, an additional check on the vibration data may be done to determine whether the vibration is also above a threshold value. A notification may be provided if both of these criteria are met. As discussed above, however, a vibration measurement may not necessarily show that a pitch bearing is damaged when the displacement measurement does show excessive displacements.

After notification, further actions may be indicated such as inspection, derating the wind turbine (to prevent further damage), stopping operation or changing the frequency of data collection if damage is accumulating but is not yet critical.

FIG. 6 illustrates schematically an example wind turbine 600 having three blades 601a-c connected to a hub 602. The hub 602 is mounted to a nacelle 603 that is mounted on top of a tower 604. Rotation of the hub 602 by the blades 601a-c drives an electric generator in the nacelle 603. Each blade 601a-c is mounted to the hub 602 with a pitch bearing of the type shown in FIG. 1, typically with the blade connected to the outer ring of the bearing and the inner ring connected to the hub 602. The wind turbine 600 is shown with the blades 601a-c in the orientation typically used when carrying out a static measurement, i.e. with one blade 601a pointing downwards with its longitudinal axis parallel to the vertical 605 and the other two blades 601b, 601c having their longitudinal axes at around 60 degrees to the vertical 605.

FIG. 7 is a photograph of an example arrangement of sensors mounted for measurement of displacement and rotation of an inner ring 703 of a wind turbine pitch bearing. A displacement sensor 705 is mounted to measure axial displacement of the inner ring 703. A rotation sensor 706 is mounted to detect rotation of the inner ring 703, in this example by detection of the passage of teeth on the inner ring by measurement of the proximity of features passing the sensor 706. In other arrangements the rotation sensor may be positioned to detect features such as bolts, nuts or bolt holes on the inner ring to detect rotation. Other techniques for measuring rotation of the inner ring relative to the outer ring may alternatively be used.

As described above in relation to the method illustrated in FIG. 5, measurements may be made on the pitch bearing during operation of the wind turbine. Such measurements may be triggered by an event. The event may be time-based or dependent on an action such as a pitching operation. For time-based triggering, a recording may be made (step 503) at a set time or after a set time period. The recording may be made for a set number of samples or time period regardless of whether the bearing is rotating. The recording may alternatively be triggered by a rotation sensor detecting that a pitching event is occurring, for example the rotation sensor 706 detecting the passage of one or more teeth. Data may be sampled continuously from the displacement sensor and a recording made over a time period that includes the pitching event.

In alternative implementations, a rotation sensor may be absent or not used. Instead, displacement data may be recorded upon being triggered by a time-based or action-based event as above, with a measurement recorded only in the form of displacement as a function of time. An action-based event could be triggered by a measure of displacement being detected outside of a predetermined range, which indicates either that the pitch bearing has suffered damage or that an error has occurred with the displacement sensor mounting.

In any of the implementations described herein, the output of the displacement sensor may be continuously monitored to check the status of the sensor. If, for example, the mean, median or standard deviation of a measured displacement changes by more than a predetermined amount over a predetermined time period, this may indicate a problem with the sensor. An alarm output may then be triggered, allowing the sensor to be checked and action to be taken.

In a general aspect therefore, a method of determining a condition of a pitch bearing of a wind turbine, the pitch bearing comprising a first ring attached to a blade of the wind turbine and a second ring attached to a hub of the wind turbine, may comprise:
monitoring displacement of the first ring in an axial direct with a displacement sensor, the axial direction parallel to a rotational axis of the pitch bearing;
upon detection of a triggering event, recording the displacement over a set period to provide a recorded displacement;
determining a variation in displacement over time from the recorded displacement; and
estimating a condition of the pitch bearing based on the variation in displacement.

The triggering event may be time-based, for example at regular time intervals, or may be a measure of rotation of the first ring or may be a measure of displacement by the displacement sensor outside of a preset threshold.

The set period for recording may be defined by a set time period, a number of samples or a measure of angular rotation of the first ring, for example by detecting passage of a number of features passing the rotation sensor.

Other embodiments are intentionally within the scope of the invention as defined by the appended claims.

1. A method of monitoring a condition of a pitch bearing of a wind turbine, the pitch bearing comprising a first ring attached to a blade of the wind turbine and a second ring attached to a hub of the wind turbine, the method comprising:
mounting a displacement sensor to the pitch bearing to measure a distance between the first ring and the second ring;
rotating the first ring relative to the second ring over an angular range; and
recording an angular position of the first ring relative to the second ring and a distance measured by the displacement sensor while rotating the first ring relative to the second ring over the angular range.

2. The method of claim 1, wherein the first ring is an inner ring and the second ring is an outer ring of the pitch bearing.

3. The method of claim 1, wherein the displacement sensor is mounted to measure a distance parallel to a rotational axis of the pitch bearing.

4. The method of claim 1, wherein the step of recording is carried out while a main rotor of the wind turbine is stationary.

5. The method of claim 1, wherein the recorded angular position is derived from a measurement of:
a gravity vector;
an elapsed time and a rotation rate; or
a detected position of the second ring relative to the first ring.

6. The method of claim 1, comprising determining a variation in the measured distance over the angular range and estimating a condition of the pitch bearing based on the variation.

7. A method of determining a condition of a pitch bearing of a wind turbine, the pitch bearing comprising a first ring attached to a blade of the wind turbine and a second ring attached to a hub of the wind turbine, the method comprising:
providing a recording of an angular position of the first ring relative to the second ring and a distance between the first ring and the second ring over an angular range;
determining a variation in the distance over the angular range; and
estimating a condition of the pitch bearing based on the variation.

8. The method of claim 7, wherein estimating a condition of the pitch bearing comprises comparing the variation in the measured distance with one or more of:
a previously stored variation in measured distance for the pitch bearing;
a modelled variation in distance for the pitch bearing;
a recorded variation in measured distance for one or more other pitch bearings of the same type.

9. The method of claim 8, wherein the one or more other pitch bearings of the same type are part of the same wind turbine and/or another wind turbine.

10. The method of claim 7, wherein determining a variation in the measured distance over the angular range comprises determining a quality value from one or more of:
a peak to peak value of the measured displacement over the angular range;
an RMS value of the measured displacement over the angular range;
a measure of deviation from a mean value of the measured displacement over the angular range; and
a kurtosis value of the measured displacement over the angular range.

11. The method of claim 10, wherein estimating a condition of the pitch bearing comprises comparing the quality value to a predetermined threshold value.

12. The method of claim 11, comprising providing a notification output if the quality value exceeds the predetermined threshold value.

13. The method of claim 7, wherein the method is performed upon being triggered by an event.

14. The method of claim 13, wherein the event is time-based or detection of a pitching operation of the pitch bearing.

15. The method of claim 14, wherein pitching operation of the pitch bearing is detected by a rotation sensor configured to detect rotation of the first ring relative to the second ring.

16. A method of determining a condition of a pitch bearing of a wind turbine, the pitch bearing comprising a first ring attached to a blade of the wind turbine and a second ring attached to a hub of the wind turbine, the method comprising:
monitoring displacement of the first ring in an axial direction with a displacement sensor, the axial direction being parallel to a rotational axis of the pitch bearing;
upon detection of a triggering event, recording the displacement over a set period to provide a recorded displacement;
determining a variation in displacement over time from the recorded displacement; and
estimating a condition of the pitch bearing based on the variation.

17. The method of claim 16, wherein the triggering event is one or more of: a time-based event; a measure of rotation of the first ring; and a measure of displacement by the displacement sensor outside a preset threshold.

18. The method of claim 16, wherein the set period for recording is defined by a set time period, a number of samples or a measure of rotation of the first ring.

19. A computer program comprising instructions for causing a computer to perform the method according to claim 7.

20. A non-transitory computer-readable medium having stored thereon program instructions executable by a processor of a device to cause the device to perform the method according to claim 7.
